(19) United States
(12) Patent Application Publication
(10) Pub. No.: US 2011/0155681 A1
(43) Pub. Date: Jun. 30, 2011

(54) Counterweight Suspension Device and Mobile Crane

(75) Inventor: Akira HANAHARA, Chita-gun (JP)

(73) Assignee: Hitachi Sumitomo Heavy Industries Construction Crane Co., Ltd., Tokyo (JP)

(21) Appl. No.: 12/979,662

(22) Filed: Dec. 28, 2010

(30) Foreign Application Priority Data
Dec. 28, 2009 (JP) 2009-297806

(51) Int. Cl. B66C 23/76; B66C 23/72

(52) U.S. Cl. 212/196

(57) ABSTRACT

A counterweight suspension device includes: a pair of suspension cylinders that suspends a counterweight, and that are hung from a first and a second hanging points provided separately in a left and right direction at a top end of a rear mast; a coupling member that couples cylinder rod ends of the pair of suspension cylinders with each other; a lifting member for lifting the counterweight, that connects a first and a second connection points of the counterweight with each of the cylinder rod ends of the pair of suspension cylinders, with the first and the second connection points provided separately in the left and right direction on the counterweight for attaching the lifting member to the counterweight; a first communication circuit through which rod chambers of the pair of suspension cylinders communicate with each other; and a second communication circuit through which bottom chambers of the pair of suspension cylinders communicate with each other.

### INCORPORATION BY REFERENCE

The disclosure of the following priority application is herein incorporated by reference:

Japanese Patent Application No. 2009-297806 filed Dec. 28, 2009

### BACKGROUND OF THE INVENTION

1. Field of the Invention

The present invention relates to a counterweight suspension device and a mobile crane including the counterweight suspension device.

2. Description of Related Art

Japanese Laid Open Patent Publication No. 2008-297112 discloses a crane that suspends a counterweight at a position a predetermined distance away from the rear end of a rotating superstructure so as to balance with load. In such crane, a mounting platform on which a plurality of weights are mounted is grounded when unloaded, whilst the plurality of weights are suspended together with the mounting platform when loaded, thereby balancing.

### SUMMARY OF THE INVENTION

In the crane stated above, however, offset in the position at which the weights are mounted on the mounting platform causes offset in the center of gravity of the whole counterweight, which may result in the mounting platform leaning when the load is suspended. In such a case, it is required to reload each of the weights so as to modify a position of the center of gravity which has been deviated horizontally, which is inefficient.

A counterweight suspension device according to a first aspect of the present invention comprises: a pair of suspension cylinders that suspends a counterweight, and that are hung from a first and a second hanging points provided separately in a left and right direction at a top end of a rear mast; a coupling member that couples cylinder rod ends of the pair of suspension cylinders with each other; a lifting member for lifting the counterweight, that connects a first and a second connection points of the counterweight with each of the cylinder rod ends of the pair of suspension cylinders, with the first and the second connection points provided separately in the left and right direction on the counterweight for attaching the lifting member to the counterweight; a first communication circuit through which rod chambers of the pair of suspension cylinders communicate with each other; and a second communication circuit through which bottom chambers of the pair of suspension cylinders communicate with each other.

According to a second aspect of the present invention, in the counterweight suspension device according to the first aspect, it is preferable that a length of the coupling member is defined so that both ends of the coupling member are placed outside of a space defined between straight lines connecting the first and the second hanging points with the first and the second connection points, respectively.

According to a third aspect of the present invention, the counterweight suspension device according to the second aspect may further comprise an upper coupling member, which is shorter than the coupling member, that couples cap ends of the pair of suspension cylinders with each other.

According to a fourth aspect of the present invention, in the counterweight suspension device according to the first aspect, it is preferable that the suspension cylinders are held swingably in the left and right direction.

According to a fifth aspect of the present invention, in the counterweight suspension device according to the first aspect, a length of the coupling member may be equal to a distance between the first and the second connection points.

A mobile crane according to a sixth aspect of the present invention comprises: the counterweight suspension device according to the first aspect; a traveling undercarriage; a rotating superstructure that is provided rotatably upon the traveling undercarriage; the rear mast that is attached to the rotating superstructure; and a connection beam that allows the counterweight to move in an up and down direction and constrains the counterweight from moving in the left and right direction with respect to the rotating superstructure.

According to a seventh aspect of the present invention, the mobile crane according to the sixth aspect may further comprise: a boom that is attached to the rotating superstructure; and a supporting pendant rope that connects a top end of the boom with the rear mast.

### BRIEF DESCRIPTION OF THE DRAWINGS

FIG. 1 is a side view of a mobile crane of an embodiment of a counterweight suspension device and a mobile crane according to the present invention.

FIGS. 2A to 2C show a top view, a rear view and a right side view of an external weight.

FIG. 3 is an illustration of the vicinity of the top end of a rear mast viewed from the rear.

FIG. 4 is a schematic illustration of a hydraulic circuit that drives suspension cylinders.

FIG. 5 illustrates an operation of the suspension device.

FIG. 6 illustrates an operation of the suspension device.

### DESCRIPTION OF PREFERRED EMBODIMENTS

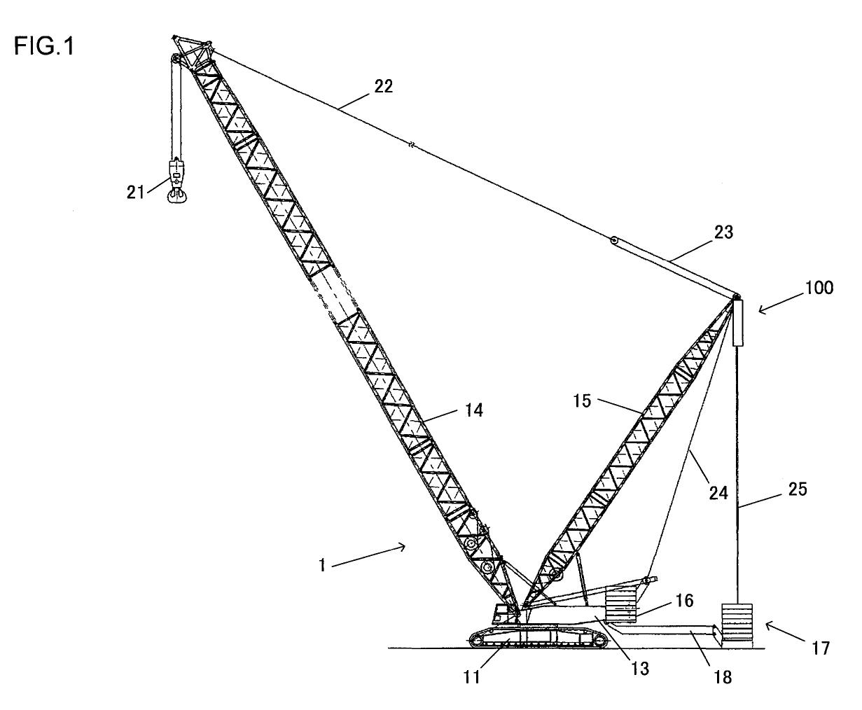

An embodiment of a counterweight suspension device and a mobile crane according to the present invention will now be explained with reference to FIGS. 1 to 6. FIG. 1 is a side view of the mobile crane of the present embodiment. A mobile crane 1 includes a traveling undercarriage (or a traveling body) 11, a rotating superstructure (or a rotating body) 13 rotatably mounted on the traveling body 11, a boom 14 and a rear mast 15 pivotally coupled to the top end portion of the rotating body 13, and a counterweight 16 attached to the rear end portion of the rotating body 13. In addition, the crane 1 includes, separately from the counterweight 16, a counterweight (or an external weight) 17 to be suspended from the top end of the rear mast 15 leaning rearward at a position a predetermined distance away from the rear end of the rotating body 13. In the following explanation, for ease of comprehension, the “right side” and the “left side” refer to the right side and the left side, respectively, of the rotating body 13 viewed from the rear to the front.

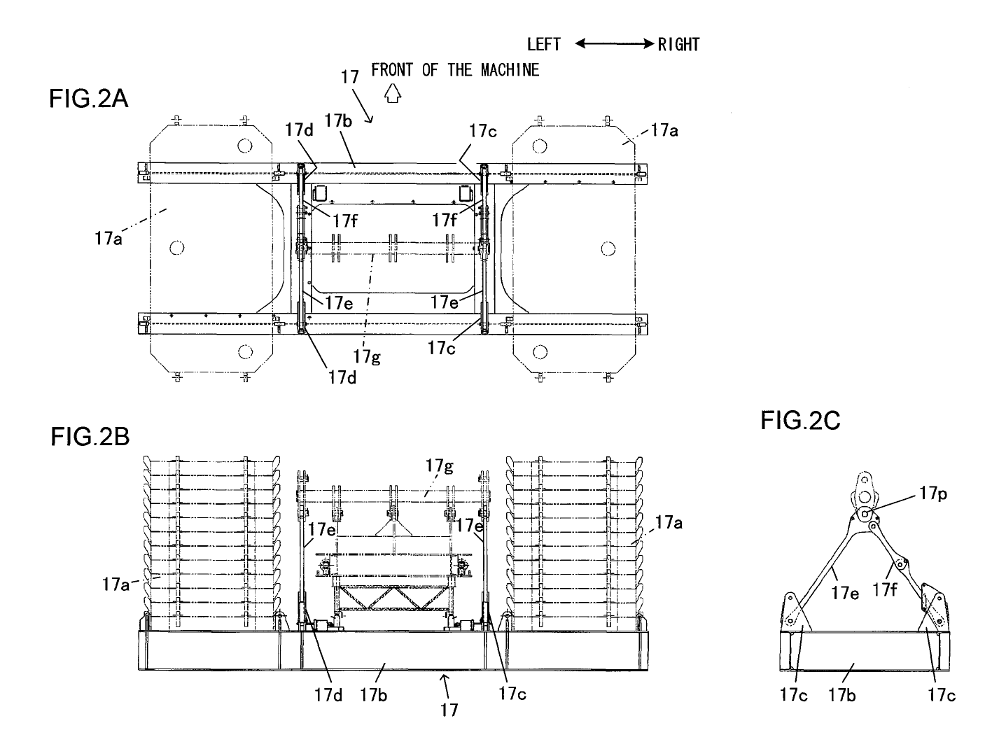

FIGS. 2A to 2C are illustrations of the external weight 17. FIG. 2A is a top view, FIG. 2B is a rear view, and FIG. 2C is a right side view. It is to be noted that in FIGS. 2A and 2B weight members 17a described below are illustrated in a two-dot chain line and in FIG. 2C illustration of the weight members 17a is curtailed. The external weight 17 includes a plurality of weight members 17a and a ladder-like mounting platform (tray) 17b on which the weight members 17a are to be mounted. The weight of the whole external weight 17 can be adjusted by changing the number of the weight members 17a mounted thereon, and a number of the weight members 17a according to the weight of the load suspended by the crane 1 are stacked on the tray 17b. The tray 17b is provided with right connection points 17c and left connection points 17d for suspension by a suspension device 100 described later.

The right connection points 17c and the left connection points 17d are provided separately in the right and left direction on the top surface of the tray 17b. The right connection points 17c and the left connection points 17d are each provided at two positions in the fore-and-aft direction. One end, that is, a bottom end of a suspending rod 17e and one end, that is, a bottom end of a suspending rod 17f are connected to the right connection points 17c. The other end, that is, a top end of the suspending rod 17e is coupled with the other end, that is, a top end of the suspending rod 17f. A connection point 17p coupling the other ends of the suspending rods 17e and 17f are connected to the bottom end of a pendant rope 25 described later. The same is true for the left connection points 17d. The other ends of the right suspending rods 17e and 17f are coupled with the other ends of the left suspending rods 17e and 17f through a rod 17g so as to maintain a distance therebetween. It is to be noted that the external weight 17 is symmetrically arranged.

A connection beam 18 is attached to the rotating body 13 as shown in FIG. 1. The connection beam 18 allows the external weight 17 to move in the up and down direction or a vertical direction and prohibits the external weight 17 to move in the left and right direction or a horizontal direction with respect to the rotating body 13.

A hook 21 is suspended from the top end of the boom 14 and a hook rope is wound around a winch unit not shown in the figures. One end of a boom pendant rope 22 is fastened to the rear portion of the top end of the boom 14, and the other end of the boom pendant rope 22 is connected to a boom hoist rope 23. The boom hoist rope 23 is wound around the winch unit. A numeral 24 represents a supporting rope of the rear mast 15.

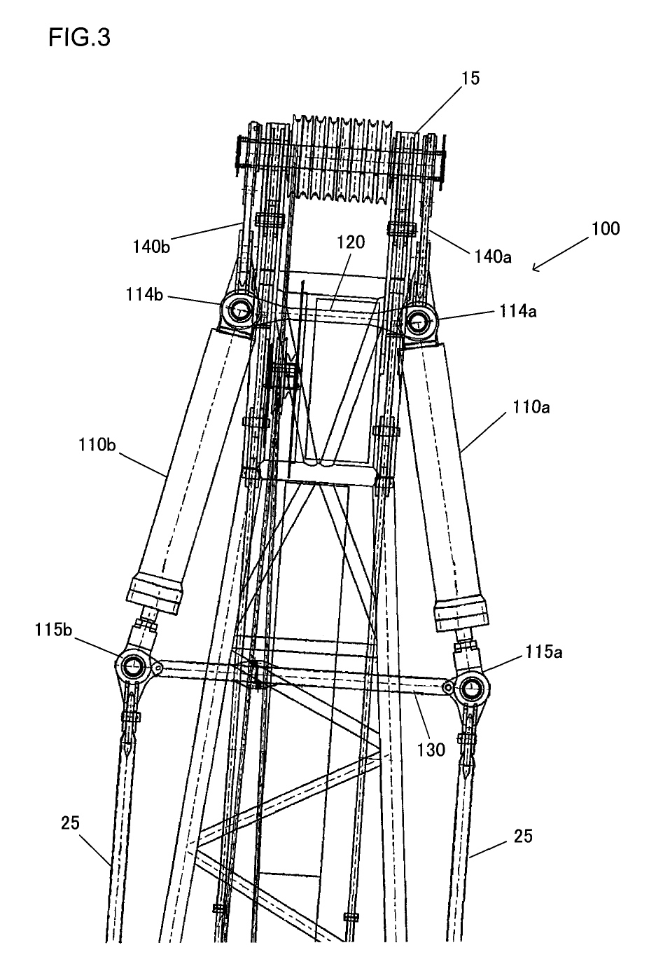

The suspension device 100 for suspending the external weight 17 is attached to the vicinity of the top end of the rear mast 15. FIG. 3 illustrates the vicinity of the top end of the rear mast 15 viewed from the rear, with cylinder rods 113a and 113b of suspension cylinders 110a and 110b to be detailed later being contracted. The suspension device 100 includes the suspension cylinders 110a and 110b, an upper coupling member 120, a lower coupling member 130, and suspending members 140a and 140b.

The suspension cylinders 110a and 110b are hydraulic cylinders for lifting up and down the external weight 17 through a lifting member (or pendant ropes) 25, which is a member for lifting the counterweight. The suspension cylinders 110a and 110b are held at the vicinity of the top end of the rear mast 15 via the suspending members 140a and 140b with the bottom side or cap end side of the cylinders up and the rod side of the cylinders down. For ease of comprehension, the suspension cylinder provided on the right of the crane 1 is assigned with a numeral 110a and the suspension cylinder provided on the left of the crane 1 is assigned with a numeral 110b.

The suspending members 140a and 140b are, as described above, members for hanging the suspension cylinders 110a and 110b from the vicinity of the top end of the rear mast 15, with the suspension cylinder 110a being attached to the suspending member 140a and the suspension cylinder 110b being attached to the suspending member 140b. The top portions of the suspending members 140a and 140b are pivotally held in the vicinity of the top end of the rear mast 15 swingably in the fore-and-aft direction. The bottom portions of the suspending members 140a and 140b pivotally hold the end portions on the bottom side of the suspension cylinders 110a and 110b so as to support the suspension cylinders 110a and 110b swingably in the left and right direction.

End portions, or cap ends, 114a and 114b on the bottom side of the suspension cylinders 110a and 110b are coupled with each other through the upper coupling member 120. A distance between the end portions 114a and 114b on the bottom side of the suspension cylinders 110a and 110b are defined by the upper coupling member 120. End portions 115a and 115b of the cylinder rods 113a and 113b of the suspension cylinders 110a and 110b are coupled with each other through the lower coupling member 130. A distance between the end portions 115a and 115b of the cylinder rods 113a and 113b of the suspension cylinders 110a and 110b are defined by the lower coupling member 130.

The length of the upper coupling member 120 is equal to the width of the rear mast 15 in the right and left direction. The length of the lower coupling member 130 is equal to the distance between the right connection points 17c and the left connection points 17d of the external weight 17 and is greater than the length of the upper coupling member 120. The upper coupling member 120, the suspension cylinders 110a and 110b, and the lower coupling member 130 form a four-link mechanism. The link mechanism is configured to be moveable in a plane extending in the up and down direction and in the right and left direction, viewed from the rear of the crane 1. It is to be noted that when the extension lengths of the cylinder rods 113a and 113b of the right and left suspension cylinders 110a and 110b are substantially equal, the link mechanism has a trapezoidal shape, viewed from the rear of the crane 1.

The top ends of the pendant ropes 25 are connected to the end portions 115a and 115b of the cylinder rods 113a and 113b of the suspension cylinders 110a and 110b. The bottom ends of the pendant ropes 25 are, as described above, connected to the other ends of the suspending rods 17e and 17f.

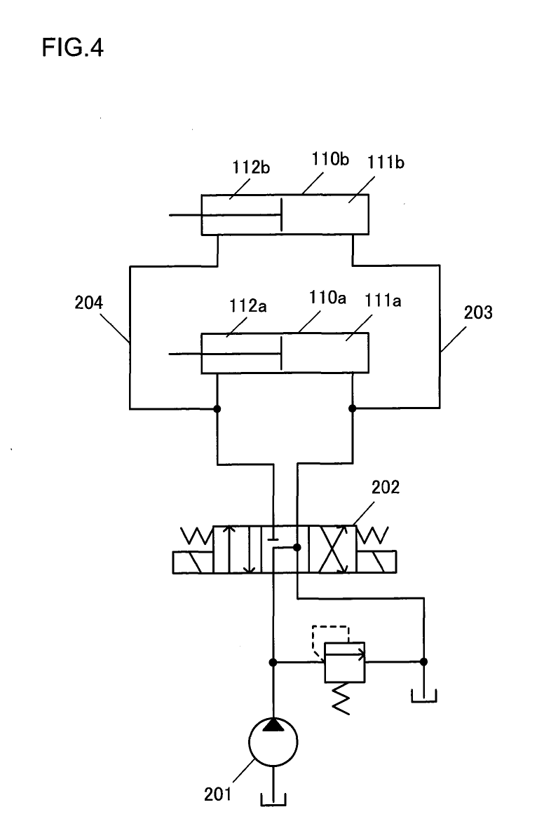

FIG. 4 is a schematic illustration of the hydraulic circuit that drives the pair of suspension cylinders 110a and 110b of the suspension device 100. Pressure oil is supplied from a hydraulic pump 201 to each of bottom-side oil chambers 111a and 111b and rod-side oil chambers 112a and 112b of the suspension cylinders 110a and 110b through a changeover valve 202. In the suspension cylinders 110a and 110b, the bottom-side oil chambers 111a and 111b are connected in communication with each other through a first communication circuit 203 and the rod-side oil chambers 112a and 112b are connected in communication with each other through a second communication circuit 204. This allows the suspension cylinders 110a and 110b to be configured so that the bottom-side oil chambers 111a and 111b are at the same pressure and the rod-side oil chambers 112a and 112b are at the same pressure. This prevents load imbalance from occurring between the suspension cylinders 110a and 110b and inhibits horizontally uneven force to be applied to the suspension device 100 and the rear mast 15.

In the crane 1, configured as above, the cylinder rods 113a and 113b of the suspension cylinders 110a and 110b of the suspension device 100 are expanded and contracted appropriately before suspending the load. At this time, the tension of the pendant ropes 25 is adjusted so that the pendant ropes 25 are relaxed and the external weight 17 is grounded when the crane 1 suspends no load, and so that the pendant ropes 25 are strained and the external weight 17 is suspended when the crane 1 lifts too much load for the counterweight 16 alone to balance. By adjusting the tension of the pendant ropes 25 in this manner, when the boom 14 and the rear mast 15 deflect or the whole crane 1 leans forward as the crane 1 suspends too much load for the counterweight 16 alone to balance, the external weight 17 is lifted from the ground and the lifted external weight 17 gives the crane 1 the moment rotating backwards, so that the crane 1 is prevented from falling forward.

Rotation of the rotating body 13 requires the external weight 17 to be lifted from the ground. Hence, when the external weight 17 is grounded, it is necessary to contract the cylinder rods 113a and 113b of the suspension cylinders 110a and 110b so as to suspend the external weight 17. However, if the center of gravity of the external weight 17 offsets in the right and left direction from the center between the right connection points 17c and the left connection points 17d, an uneven load is applied to the right connection points 17c and the left connection points 17d when the external weight 17 is being lifted, thereby causing the external weight 17 to lean in the left and right direction.

If, for instance, the center of gravity of the external weight 17 offsets to the left from the center between the right connection points 17c and the left connection points 17d, a force acts as the left side of the external weight 17 sags below the right side thereof when the external weight 17 is suspended. If the center of gravity of the external weight 17 offsets to the right from the center between the right connection points 17c and the left connection points 17d, on the other hand, a force acts as the right side of the external weight 17 sags below the left side thereof when the external weight 17 is suspended. As a result, existing cranes require the weight members 17a to be reloaded so that a left-and-right offset position of the center of gravity of the external weight 17 is centered in the left and right direction. Such work for reloading the weight members 17a causes the crane work to be interrupted, thereby reducing work efficiency.

In the suspension device 100 of the present embodiment, on the other hand, even if the center of gravity of the external weight 17 offsets to the left or right from the center between the right connection points 17c and the left connection points 17d, the external weight 17 does not lean so much in the left and right direction when the external weight 17 is suspended. This will be explained below in detail.

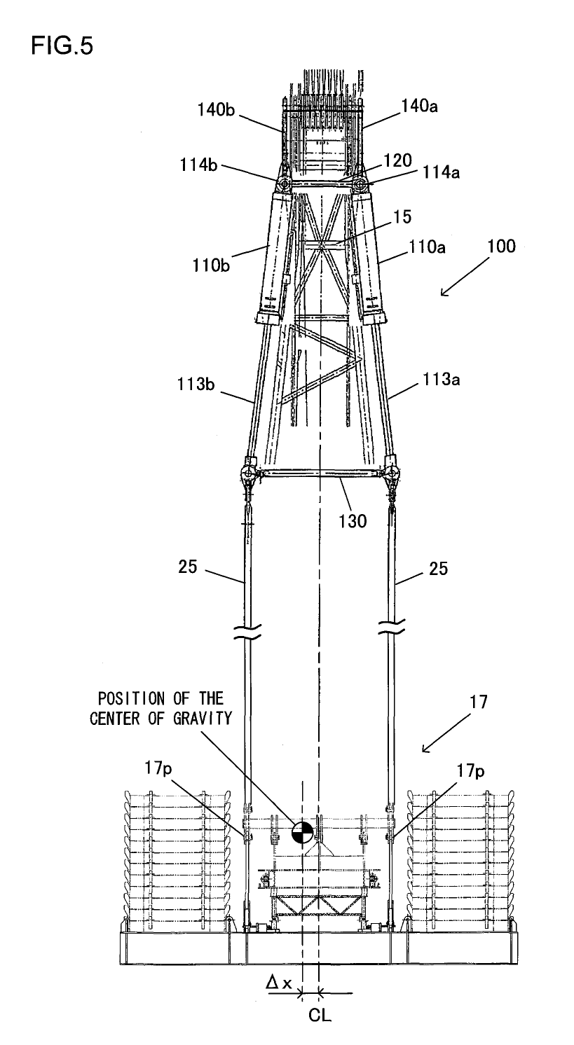

An explanation will now be made as to a case in which the grounded external weight 17 is to be suspended by contracting the cylinder rods 113a and 113b of the suspension cylinders 110a and 110b when the center of gravity of the external weight 17 offsets to the left by Δx from the center CL between the right connection points 17c and the left connection points 17d as shown in FIG. 5 for example. As pressure oil is supplied to the rod-side oil chambers 112a and 112b by the changeover valve 202 being switched with an operating switch not shown in the figures, the cylinder rods 113a and 113b contract. As the contraction of the cylinder rods 113a and 113b progresses and the pendant ropes 25 are strained, reaction force from the pendant ropes 25 increases the pressure in the rod-side oil chambers 112a and 112b.

Since the rod-side oil chambers 112a and 112b are connected in communication with each other through the second communication circuit 204 as described above, further pressure oil supply preferentially contracts the cylinder rod of the suspension cylinder with less load among the suspension cylinders 110a and 110b, i.e., the cylinder rod 113a of the right-side suspension cylinder 110a, which is on the opposite side of the center of gravity offset. At this time, since the cylinder rods 113a and 113b are pulled down by the pendant ropes 25, the cylinder rods 113a and 113b are not allowed to move so much to make any difference in the heights of their ends 115a and 115b. Instead, the lower coupling member 130 moves to the left so as to accommodate the difference in lengths of the right and left cylinder rods 113a and 113b.

Since the connection beam 18 constrains the external weight 17 from moving in the left and right direction as described earlier, even if the lower coupling member 130 moves to the left so as to pull up the external weight 17 from slightly diagonally up and left, the external weight 17 does not actually move to the left. Thus, when the lower coupling member 130 has moved to the left to some extent, a force that acts to have the lower coupling member 130 returned to the right is applied to the lower coupling member 130 due to the reaction force from the pendant ropes 25. This causes the lower coupling member 130 to stop moving further to the left.

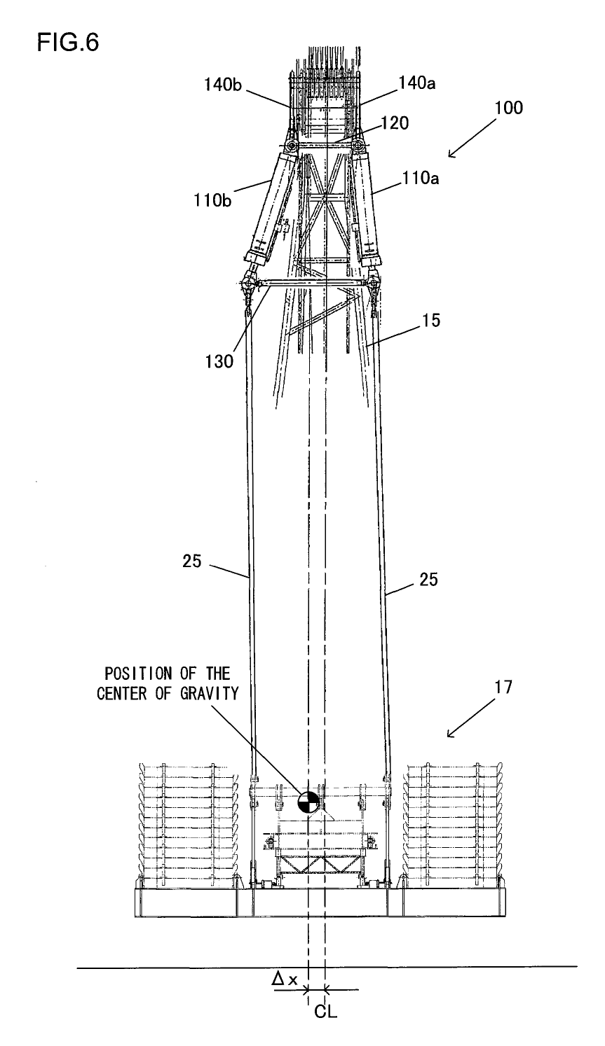

In addition, the force that acts to have the lower coupling member 130 returned to the right acts on the suspension cylinder 110a with less load as a force to expand the cylinder rod 113a and acts on the suspension cylinder 110b with greater load as a force to contract the cylinder rod 113b. As a result, the suspension cylinders 110a and 110b become substantially equal in load and the rod-side oil chambers 112a and 112b become substantially equal in pressure, and the right and left cylinder rods 113a and 113b will then contract in the substantially same manner. This causes, as shown in FIG. 6, the external weight 17 to move upwards without leaning too much in the left side.

It is to be noted that the same is true for a case in which too much load for the counterweight 16 alone to balance is suspended without contracting the cylinder rods 113a and 113b of the suspension cylinders 110a and 110b, so that the external weight 17 is lifted from the ground by the crane 1 leaning forward.

The following operations and advantageous effects can be achieved by the crane 1 of the present embodiment.

(1) It is arranged that the end portions 114a and 114b on the bottom side of the suspension cylinders 110a and 110b are separated laterally or in the right and left direction from one another and held independently, and the end portions 115a and 115b of the cylinder rods 113a and 113b are coupled with each other through the lower coupling member 130. The bottom-side oil chambers 111a and 111b are connected in communication with each other through the first communication circuit 203 and the rod-side oil chambers 112a and 112b are connected in communication with each other through the second communication circuit 204. This prevents the external weight 17 from leaning greatly in the left and right direction when the external weight 17 is suspended even if the position of the center of gravity of the external weight 17 offsets in the left and right direction. As a result, since it is not necessary to reload the weight members 17a even if the position of the center of gravity of the external weight 17 offsets in the left and right direction, work efficiency of the crane work is improved.

(2) It is arranged that the length of the lower coupling member 130 is greater than that of the upper coupling member 120. As a result, even if the left and right cylinder rods 113a and 113b of the suspension cylinders 110a and 110b become uneven in length for some extent due to offset of the position of the center of gravity of the external weight 17, the cylinder rods 113a and 113b are prevented from being more uneven in length, and thus, leaning of the external weight 17 is inhibited.

(3) The link mechanism is arranged by coupling the end portions 114a and 114b on the bottom side of the suspension cylinders 110a and 110b with each other through the upper coupling member 120 and by coupling the end portions 115a and 115b of the cylinder rods 113a and 113b with each other through the lower coupling member 130. As a result, since the separation between the suspension cylinders 110a and 110b in the left and right direction can be defined at the top and the bottom, that is, two vertically separated locations, of the suspension cylinders 110a and 110b and no force in the radial direction is applied to the suspension cylinders 110a and 110b, the life of the suspension cylinders 110a and 110b will not be shortened.

Variations

(1) While in the above explanation, the length of the upper coupling member 120 is arranged to be equal to the width of the rear mast 15 in the left and right direction and the length of the lower coupling member 130 is arranged to be equal to the separation between the right connection points 17c and the left connection points 17d of the external weight 17, the present invention is not limited thereto. The length of the lower coupling member 130 may be defined so that the end portions 115a and 115b of the cylinder rods 113a and 113b are located at least outside of the space defined between a first line and a second line to be described later even if the lower coupling member 130 is moved in the left and right direction when the external weight 17 is suspended. Here, the first line refers to a straight line connecting the end portion 114a on the bottom side of the suspension cylinder 110a with the connection point 17p at which the other ends of the suspending rods 17e and 17f connected to the right connection points 17c are coupled with each other. The second line refers to a straight line connecting the end portion 114b on the bottom side of the suspension cylinder 110b with the connection point 17p at which the other ends of the suspending rods 17e and 17f connected to the left connection points 17d are coupled with each other.

(2) While in the above explanation, it is arranged that the end portions 114a an 114b on the bottom side of the suspension cylinders 110a and 110b are located up and the end portions 115a and 115b of the cylinder rods 113a and 113b are located down, the present invention is not limited thereto. In other words, it may be arranged that the end portions 114a and 114b on the bottom side of the suspension cylinders 110a and 110b are located down and the end portions 115a and 115b of the cylinder rods 113a and 113b are located up.

(3) While in the above explanation, an example of the mobile crane 1 was explained, the present invention is not limited thereto, i.e., it may be applied to a non-mobile crane.

(4) The embodiments and variations described above may each be adopted in combination.

It is to be noted that the present invention may be embodied in any way other than those described in reference to the embodiments, and includes counterweight suspension devices with a variety of structures and mobile cranes with a variety of structures that include the suspension devices comprising a pair of suspension cylinders that suspends a counterweight, and that are hung from a first and a second hanging points provided separately in a left and right direction at a top end of a rear mast; a coupling member that couples cylinder rod ends of the pair of suspension cylinders with each other; a lifting member for lifting the counterweight, that connects a first and a second connection points of the counterweight with each of cylinder rod ends of the pair of suspension cylinders, with the first and the second connection points provided separately in the left and right direction on the counterweight for attaching the lifting member to the counterweight; a first communication circuit through which rod chambers of the pair of suspension cylinders communicate with each other; and a second communication circuit through which bottom chambers of the pair of suspension cylinders communicate with each other.

What is claimed is:

1. A counterweight suspension device, comprising:
a pair of suspension cylinders that suspends a counterweight, and that are hung from a first and a second hanging points provided separately in a left and right direction at a top end of a rear mast;
a coupling member that couples cylinder rod ends of the pair of suspension cylinders with each other;
a lifting member for lifting the counterweight, that connects a first and a second connection points of the counterweight with each of the cylinder rod ends of the pair of suspension cylinders, with the first and the second connection points provided separately in the left and right direction on the counterweight for attaching the lifting member to the counterweight;
a first communication circuit through which rod chambers of the pair of suspension cylinders communicate with each other; and
a second communication circuit through which bottom chambers of the pair of suspension cylinders communicate with each other.

2. A counterweight suspension device according to claim 1, wherein:
a length of the coupling member is defined so that both ends of the coupling member are placed outside of a space defined between straight lines connecting the first and the second hanging points with the first and the second connection points, respectively.

3. A counterweight suspension device according to claim 2, further comprising:
an upper coupling member, which is shorter than the coupling member, that couples cap ends of the pair of suspension cylinders with each other.

4. A counterweight suspension device according to claim 1, wherein:
the suspension cylinders are held swingably in the left and right direction.

5. A counterweight suspension device according to claim 1, wherein:
a length of the coupling member is equal to a distance between the first and the second connection points.

6. A mobile crane, comprising:
the counterweight suspension device according to claim 1;
a traveling undercarriage;
a rotating superstructure that is provided rotatably upon the traveling undercarriage;
the rear mast that is attached to the rotating superstructure; and
a connection beam that allows the counterweight to move in an up and down direction and constrains the counterweight from moving in the left and right direction with respect to the rotating superstructure.

7. A mobile crane according to claim 6, further comprising:
a boom that is attached to the rotating superstructure; and
a supporting pendant rope that connects a top end of the boom with the rear mast.
